(19) United States
(12) Patent Application Publication
(10) Pub. No.: US 2012/0215926 A1
(43) Pub. Date: Aug. 23, 2012

(54) Mechanism for Quick Data Path Setup by Cloning Session Content

(75) Inventor: Xuechen Yang, Austin, TX (US)

(73) Assignee: Cisco Technology, Inc., San Jose, CA (US)

(21) Appl. No.: 13/032,162

(22) Filed: Feb. 22, 2011

(51) Int. Cl. G06F 15/16

(52) U.S. Cl. 709/227; 709/230; 709/238

(57) ABSTRACT

A custom interface depth may be provided. A content stream, such as a three-dimensional television signal, comprising a plurality of video planes may be displayed. In response to receiving a request to adjust a depth of at least one of the video planes, the display depth of the requested video plane may be adjusted relative to at least one other video plane.

### BACKGROUND

In the past decade, peer-to-peer (“P2P”) applications and related content sharing software has gained popularity among Internet users. When a P2P application is started, it may spawn tens of thousands of sessions in the matter of seconds. Depending upon the particular P2P application, users may observe constant session creation and tear-down on the network. Such traffic patterns and concentrated network activity may cause various problems to Internet gateways. Problems may especially occur on residential gateways, as most P2P applications may be running of home networks. Current systems do not provide for minimizing the time and processing power of each section to avoid such problems.

### BRIEF DESCRIPTION OF THE DRAWINGS

The accompanying drawings, which are incorporated in and constitute a part of this disclosure, illustrate various embodiments. In the drawings:

FIG. 1 is a block diagram of an operating environment;

FIG. 2 is a block diagram of an operating environment;

FIG. 3 is a flow chart of a method for providing a quick datapath setup;

FIG. 4 is a flow chart of a method for providing a quick datapath setup;

FIG. 5 is a block diagram of a computing device.

### DESCRIPTION OF EXAMPLE EMBODIMENTS OVERVIEW

Consistent with some embodiments, systems and methods are disclosed to optimize the session setup process for a router/gateway by employing a session-grouping and cloning mechanism. This mechanism may improve the overall performance of the router/gateway and equip it to better handle the unusual P2P traffic patterns.

It is to be understood that both the foregoing general description and the following detailed description are examples and explanatory only, and should not be considered to restrict the application's scope, as described and claimed. Further, features and/or variations may be provided in addition to those set forth herein. For example, embodiments may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of may be described, modifications, adaptations, and other implementations are possible. For example, substitutions, additions, or modifications may be made to the elements illustrated in the drawings, and the methods described herein may be modified by substituting, reordering, or adding stages to the disclosed methods.

Most modern routers and/or gateways (“routing devices”) may have various security and quality of service functionalities that may require session-specific processing. Internally, routers and/or gateways may create a unique data structure and determine the session-specific processing policy, processing rules, and processing instructions during the session setup stage (i.e., when the first few packets are being exchanged between the two hosts for the new protocol session). Such session setup processes may be slower than the processing for the subsequent traffic after the internal session structure has been established. The data path for session setup traffic may be referred to as the “slow path”. Similarly, the data path for the subsequent traffic may be referred to as the “fast path”.

When a P2P application starts, tens of thousands of Internet sessions may be created. Many of these created sessions may be accompanied by a flood of DNS query messages. Because each session setup message goes through the slow path, the CPU of the router/gateway may easily be overloaded and the processing power may be drained. To make such a matter worse, a residential gateway may perform DNS proxy functions for LAN-side DNS queries. Such proxying may slow down the router/gateway even more when a massive amount of DNS queries are simultaneously received.

As such, the P2P application, or other content sharing applications, may effectively launch unintended Denial of Service (“DoS”) attacks on the router/gateway. This may result in a number of problems for the end user including: 1) losing Internet access for other applications; 2) wireless clients losing their connections to the router/gateway (if the router/gateway is operating as an access point); 3) VoIP may discontinue working; and 4) IPTV stream may freeze and become unwatchable.

To avoid these problems, embodiments may be described to minimize the time and processing power required to set up each individual session. The router/gateway may avoid processing session setup packets on the slow path. Router/gateway may setup the sessions quickly by cloning session processing information without going through the slow path.

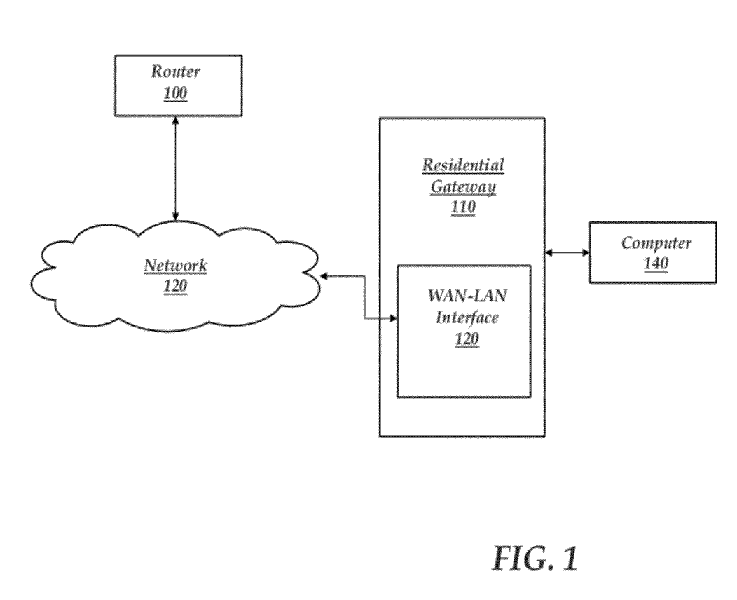

FIG. 1 is a block diagram illustrating an operating environment for optimizing the session setup process. A router 100 may be situated, for example, on a network path such as the Internet. Router 100 may provide IP address routing, network address translation (“NAT”), DHCP functions, firewall functions, and LAN connectivity similar to a network switch.

Router 100 may be a self-contained component, using internally-stored firmware. Router 100 may be OS-independent (i.e. can be used with any operating system). In some embodiments, router 100 may operate as a wireless router. A wireless router may perform the same functions as a non-wireless router, but also allow connectivity for wireless devices with the LAN, or between the wireless router and another wireless router. (The wireless router-wireless router connection can be within the LAN or can be between the LAN and a WAN.)

Another router device may be a residential gateway 110. Residential gateway 110 may be a home networking device, used as a gateway to connect devices in the home to the Internet or to another WAN. Residential gateway 110 may comprise a DSL modem or cable modem, a network switch, providing LAN switching, a router, and a wireless access point.

Residential gateway 110 may allow the connection of a LAN (e.g, used in the home) to a WAN via interface 130. The WAN can often be Internet 120 or can merely be a larger LAN of which the home is a part (such as a municipal WAN that provides connectivity to the residences within the municipality). WAN connectivity may be provided through DSL, cable modem, a broadband mobile phone network, or other connections.

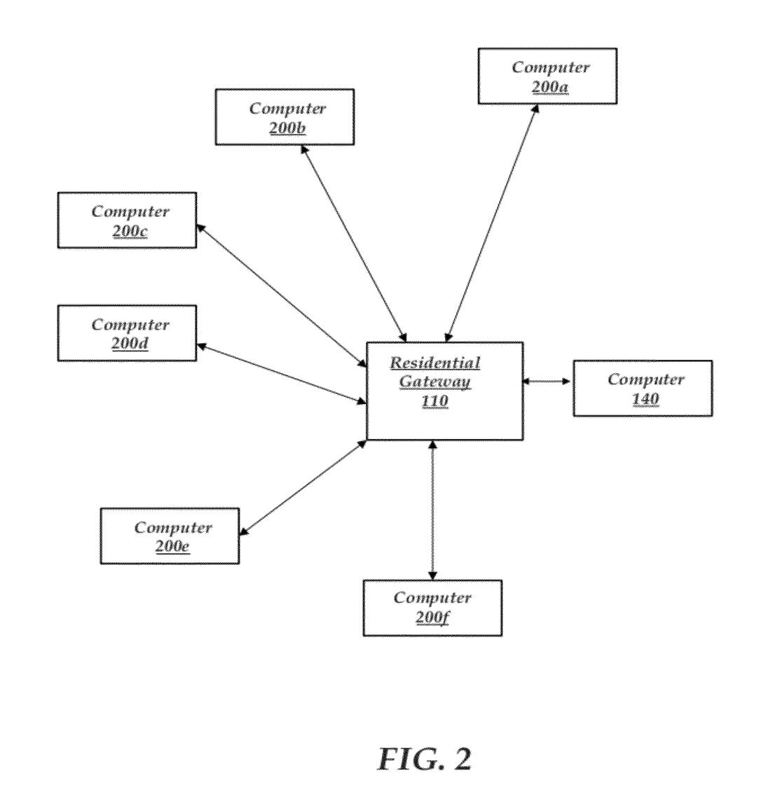

Residential gateway may further be in communication with a residential computer 140, which may be a personal computer. Residential computer 140 may be running a P2P application and establishing communications as illustrated in FIG. 2.

Residential computer 140 may be establishing a plurality of connections to a plurality of peer computers 200a-200f. Each connection may have been established through a router, such as residential gateway 110. As discussed above, many of these created sessions may be accompanied by a flood of DNS query messages. Because each session setup message goes through the slow path, the CPU of residential gateway 110 may be overloaded.

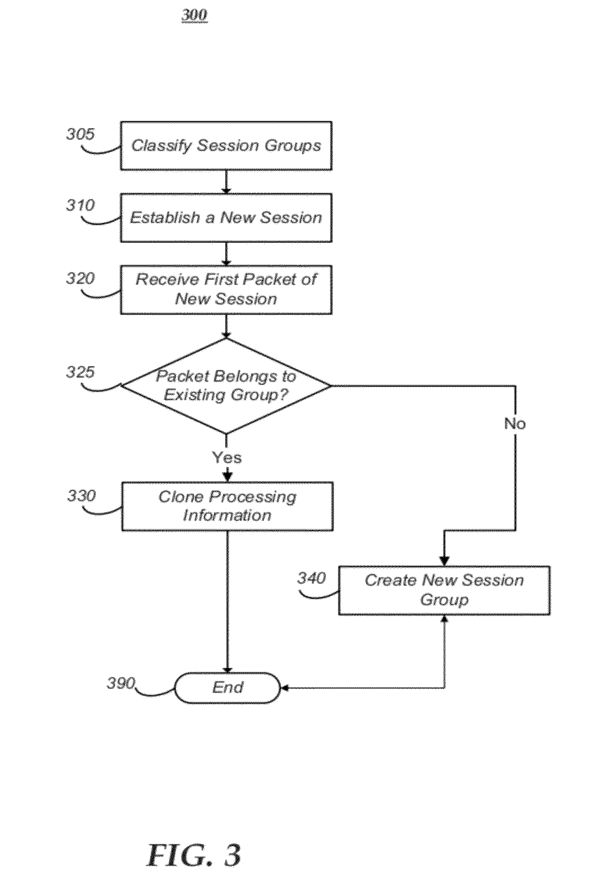

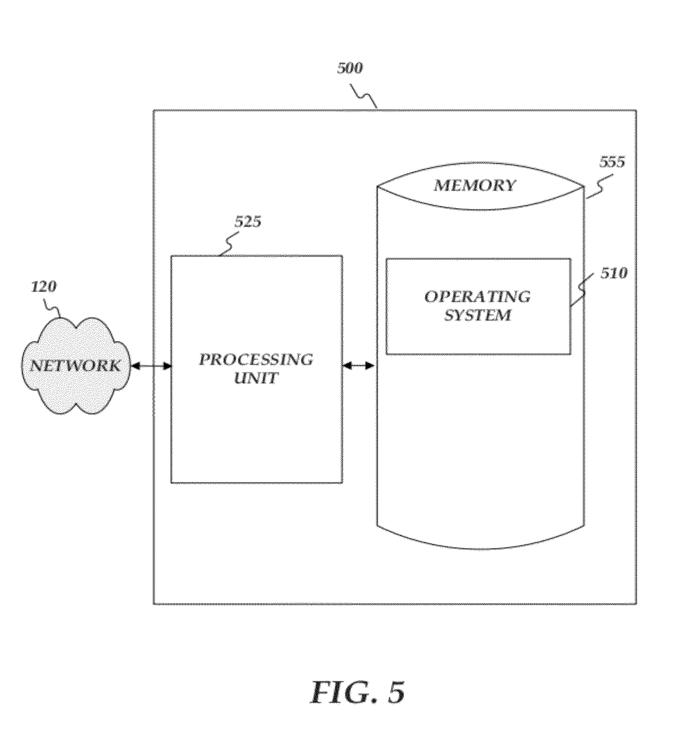

FIG. 3 is a flow chart setting forth the general stages involved in a method 300 consistent with embodiments for cloning session processing information without going through the slow path. Method 300 may be implemented using a computing device 500 as described in more detail below with respect to FIG. 5. Ways to implement the stages of method 300 will be described in greater detail below. Method 300 may begin at starting block 305 wherein network sessions may be classified into different groups.

Sessions may be grouped according to implementation-specific protocols. For example, in a residential gateway deployment, outgoing LAN-to-WAN sessions may be grouped by matching source information (i.e., the LAN host) and the next hop IP addresses. The incoming WAN-to-LAN sessions may be grouped by matching the destinations (i.e., the LAN host's public address), IP address, and port number.

Regardless of the method used to group the sessions, the grouping should ensure that the majority of the members of a group share the same processing information. This shared information may be more easily cloned. For example, the residential gateway may group outgoing sessions by source and next hop IP to ensure that all sessions may share the same NAT IP address. Each network session group may share the same processing information. In some embodiments, processing information may comprise: processing policy, processing rules, and processing instructions.

Method 300 may proceed to stage 310 where computing device 500 may create a new session group upon establishment of a first session. This first session group may be processed on the slow path. The method may then proceed to stage 320 where computing device 500 may receive the first packet of the new session.

Method 300 may proceed to stage 325 where it may be determined whether the newly received packet belongs to an existing session group. Determining whether session groups match may comprise classifying the session by matching the source and next hop IP address against the database of existing session groups. In some embodiments, this may require a small amount of group-classification code to be executed on the fast path, which does not compromise performance.

If it is determined that the session belongs to an existing session group, method 300 may then advance to stage 330 where computing device 500 may clone the session group's processing information to the newly created session and subsequently end method 300 at step 390.

If it is determined that the session does not belong to an existing session group, method 300 may then advance to stage 340 where computing device 500 may create a new session group associated to the newly received packet. Method 300 may then end at step 390.

In most cases, the processing information may be cloned directly. For example, the NAT IP address information may be easily cloned. In some embodiments, the processing information parameters may require modification and may not be directly cloned. One such example may be a quality of service tagging or marking value. Processing information parameters may be referred to as “session-specific parameters”. For session-specific parameters, small functions may need to be deployed to determine the associated values. Such code may be executed on the fast path, which does not compromise performance.

Once the processing information is cloned, the session may be considered established. Once the session has been established, the subsequent session traffic may be processed directly on the fast path.

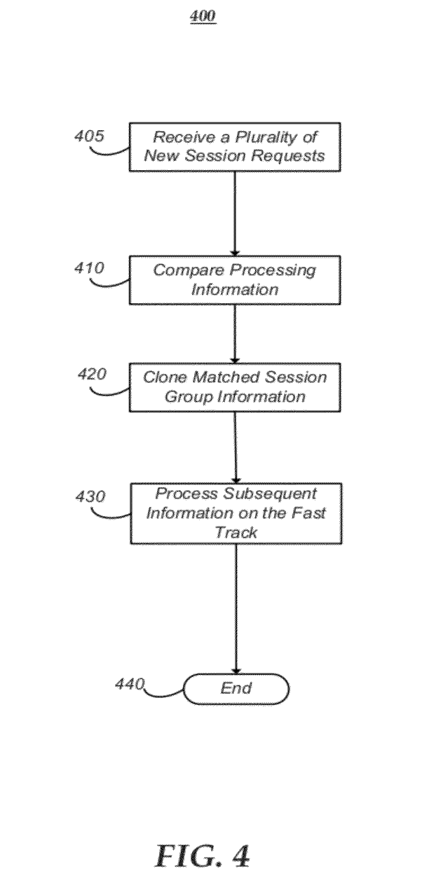

FIG. 4 is a flow chart setting forth the general stages involved in a method 400 consistent with embodiments for cloning session processing information without going through the slow path. Method 400 may be implemented using a computing device 500 as described in more detail below with respect to FIG. 5. Ways to implement the stages of method 400 will be described in greater detail below. Method 400 may begin at starting block 405 wherein a plurality of new session requests may be received at for example, residential gateway 110.

The plurality of new session requests may be related to a P2P application attempting to connect to a plurality of peers. Method 400 may then advance to stage 410 and compare processing information of a new session request to a database of processing information associated with established session groups. For example, comparing processing information may comprise matching an address of a host, an IP address, and a port number. Alternatively, comparing processing information may comprise matching host information and next hop IP address information.

Method 400 may now proceed to stage 420 where processing information may be cloned from a matching established session group to the new session request. In some embodiments, a subset of the processing information parameters may be modified before cloning. Once the new session is established and has obtained the cloned processing information, method 400 may proceed to stage 430. At stage 430, new traffic received on the established session group is processed on a fast track and may avoid the slow track. Method 400 may end at step 440.

Above described embodiments may minimize the number of CPU cycles required for session setup and may greatly reduce the impact made by P2P applications. This can be especially important for triple-play type of gateways/routers. It should be understood that while embodiments have been described in the context of a P2P application, embodiments may be applicable to all network protocols and activities.

Some embodiments may comprise a method for improving session setup speed. The method may comprise classifying a plurality of sessions into a plurality of session groups; receiving a first packet in a first protocol session; determining whether the first packet belongs to an existing session group; and if the first packet belongs to an existing session group, cloning processing information associated with the existing session group to the first protocol session.

Some embodiments may comprise a system for improving session setup speed. The system may comprise: a routing device and a processor coupled to the routing device. The processor may be operative to receive a packet and determine whether the packet belongs to an existing session group. If the packet belongs to an existing session group, processing information associated with the existing session group may be cloned to the session associated with the packet.

Some embodiments may comprise a method for improving session setup speed. The method may comprise: receiving a plurality of new session requests; comparing processing information of a first one of the plurality of new session requests to a database of processing information associated with established session groups; and cloning processing information from one of the established session groups to the first one of the plurality of new session requests.

FIG. 5 illustrates a computing device 500. Computing device 500 may include processing unit 525 and memory 555. A memory 555 may comprise a dynamic random access memory (DRAM) and/or a flash memory for storing executable programs and related data components of various applications and modules for execution by router 100. Memory 555 may be coupled to processor 525 for storing configuration data and operational parameters, such as commands that are recognized by processor 525.

Memory 555 may include software configured to execute application modules such as an operating system 510. Computing device 500 may execute, for example, one or more stages included in method 300 and method 400 as described above with respect to FIGS. 3 and 4. Moreover, any one or more of the stages included in method 300 or method 400 may be performed on any router device.

Computing device 500 may be implemented using a personal computer, a network computer, a mainframe, a computing appliance, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

Some embodiments, for example, are described above with reference to block diagrams and/or operational illustrations of methods, systems, and computer program products according to embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages.

All rights including copyrights in the code included herein are vested in and the property of the Applicant. The Applicant retains and reserves all rights in the code included herein, and grants permission to reproduce the material only in connection with reproduction of the granted patent and for no other purpose.

What is claimed is:

1. A method for improving session setup speed, the method comprising:
classifying a plurality of sessions into a plurality of session groups;
receiving a first packet in a first protocol session;
determining whether the first packet belongs to an existing session group; and
if the first packet belongs to an existing session group, cloning processing information associated with the existing session group to the first protocol session.

2. The method of claim 1, wherein the processing information comprises processing policy, processing rules, and processing instructions.

3. The method of claim 1, wherein sessions are grouped by matching host information and next hop IP address information.

4. The method of claim 1, wherein sessions are grouped by matching an address of a host, an IP address, and a port number.

5. The method of claim 1, wherein a subset of the processing information parameters are modified before cloning.

6. The method of claim 5, wherein the subset of the processing information comprises a service tagging value.

7. The method of claim 5, further comprising: deploying one or more functions for execution on a fast track to determine the value of modified parameters.

8. The method of claim 1, wherein subsequent traffic on the first protocol session is processed directly on a fast path.

9. The method of claim 1, further comprising: establishing a new session group associated with the first packet if the first packet does not belong to an existing session group.

10. The method of claim 9, wherein subsequent traffic on the new session group is processed on a fast path.

11. A system for improving session setup speed, the system comprising:
a routing device; and
a processor coupled to the routing device, wherein the processor is operative to:
receive a packet;
determine whether the packet belongs to an existing session group; and
if the packet belongs to an existing session group, clone processing information associated with the existing session group to the session associated with the packet.

12. The system of claim 11, wherein the routing device comprises a residential gateway.

13. The system of claim 12, wherein the processor is further operative to:
modify session-specific parameters before cloning the processing information.

14. The system of claim 13, wherein the processor is further operative to:
execute code modules on a fast track to determine the values associated with the session-specific parameters.

15. A method for improving session setup speed, the method comprising:
receiving a plurality of new session requests;
comparing processing information of a first one of the plurality of new session requests to a database of processing information associated with established session groups; and
cloning processing information from one of the established session groups to the first one of the plurality of new session requests.

16. The method of claim 15, wherein the plurality of new session requests are related to a P2P application.

17. The method of claim 16, wherein subsequent traffic on the new session is processed on a fast track.

18. The method of claim 16, wherein a subset of the processing information parameters are modified before cloning.

19. The method of claim 15, wherein comparing processing information further comprises matching an address of a host, an IP address, and a port number.

20. The method of claim 15, wherein comparing processing information further comprises matching host information and next hop IP address information.
